(19) United States
(12) Patent Application Publication
(10) Pub. No.: US 2006/0010695 A1
(43) Pub. Date: Jan. 19, 2006

(54) Handle structure of scissors

(76) Inventor: Shu-Ling Wu, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 10/893,304

(22) Filed: Jul. 19, 2004

(51) Int. Cl. B26B 13/20

(52) U.S. Cl. 30/232; 30/254

(57) ABSTRACT

A handle structure of scissors provides ring handle parts being detachably fastened to the elongated stems of the scissors. Each of the ring handle part has a projection seat with a square shaped engaging hole. Each of the elongated stems has an axial hole corresponding to the engaging hole and the respective ring handle part can be fastened to the respective elongated stem with an engaging bolt respectively in company with an O shaped rubber ring, rubber washers and a nut. Hence, the ring handle parts can be rotated to any angular positions with respect to the elongated stems so as to allow the blades of the scissors being disposed at various inclining angles under a condition of keeping the fingers, palm and elbow being in a state of unmoving easily according to human engineering for a hand.

### BACKGROUND OF THE INVENTION

1. Field of the Invention

The present invention is related to a handle structure of scissors and particularly to a handle structure of scissors, in which the ring handle parts can be turned to keep the hand holding the scissors unmoved in spite of the scissors changing positions.

2. Brief Description of Related Art

The conventional structure of scissors shown in FIGS. 1 and 2 mostly is provided with two symmetrical blades 11 integrated with a handle stem 12 and a ring handle part 13 respectively. The fingers 1 are inserted through the ring handle parts 13 to keep contact with the handle stems 12. Further, one of the ring handle parts 13 is provided with a handle tail 14 being contacted with a further finger 1. The preceding conventional structure scissors has the following shortcomings:

1. When the blades 11 are disposed upwards, the handle stems 12 and the ring handle parts 13 are disposed downwards as shown in FIG. 3A. When the blades 11 are disposed horizontally, the handle stems 12 and the ring handle parts 13 are disposed horizontally too as shown in FIG. 3B. When the blades 11 is disposed toward downward, the handle stems 12 and the ring handle parts 13 are disposed upwards as shown in FIG. 3C. Hence, the fingers 1, the palm 2 and the elbow 3 has to move corresponding to different positions of the scissors shown in FIGS. 3A, 3B and 3C. Especially, the elbow 3 has to be lifted upwards for the positions shown in FIGS. 3B and 3C and it is not comfortable from standpoint of human engineering. As a result, the elbow 3 is easy to become fatigued and even get hurt to such as muscle or tendon.

2. Due to the ring handle parts 13 being integral with the handle stems and the blades, the ring handle parts 13 are incapable of performing angular adjustment and it is very inconvenient that the fingers 1, the palm 2 and the elbow 3 have to change the angular positions thereof in order to comply with position changes of the scissors.

### SUMMARY OF THE INVENTION

A main object of the present invention is to provide a handle structure of scissors with which the ring handle parts are detachably joined to the handle stems so that the fingers, the palm and the elbow can be kept unmoved during the ring handle parts being rotated to change angular positions with respect the handle stems for cutting purpose and an easy operation can be obtained effectively according to the human engineering.

Another object of the present invention is to provide a handle structure of scissors in which the ring handle parts are assembled to the handle stems in company with a projection seat, an axial hole, an engaging bolt, rubber washers and an O shaped rubber ring so that the ring handle parts can be kept at an angular position with respect to the handle stem unless the ring handle parts are forced to rotate to another angular position.

### BRIEFE DESCRIPTION OF THE DRAWINGS

The detail structure, the applied principle, the function and the effectiveness of the present invention can be more fully understood with reference to the following description and accompanying drawings, in which:

FIG. 1 is a perspective view of a conventional scissors;

FIG. 2 is a plan view of the scissors shown in FIG. 1 illustrating being held with fingers;

FIG. 3A is a plan view illustrating the scissors in a state of using for cutting hairs with the blades thereof being disposed upwards;

FIG. 3B is plan view illustrating the scissors in a state of using for cutting hairs with the blades thereof being disposed horizontally;

FIG. 3C plan view illustrating the scissors in a state of using for cutting hairs with the blades thereof being disposed downwards;

FIG. 4 is a partly exploded perspective view of scissors according to the present invention;

FIG. 5 is a sectional view of an annular handle part of the scissors according to the present invention;

FIG. 6 is a perspective view of the scissors according to the present invention illustrating the annular handle part being assembled completely;

FIG. 7 is a perspective view illustrating the annular handle part being capable of being rotated an angle with respect to the main body of the scissors; and

FIG. 8A is a plan view illustrating the annular handle part being rotated in a state of the blades being disposed upwards;

FIG. 8B is a plan view illustrating the annular handle part being rotated in a state of the blades being disposed horizontally; and

FIG. 8C is a plan view illustrating the annular handle part being rotated in a state of the blades being disposed downwards.

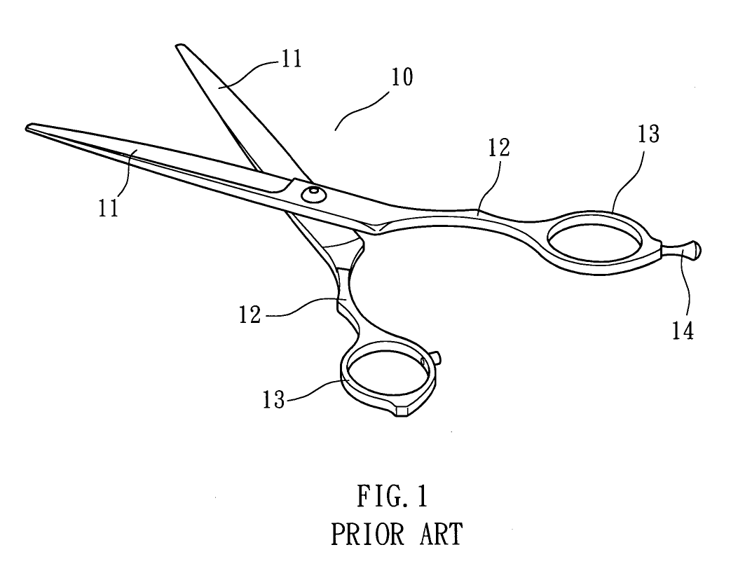

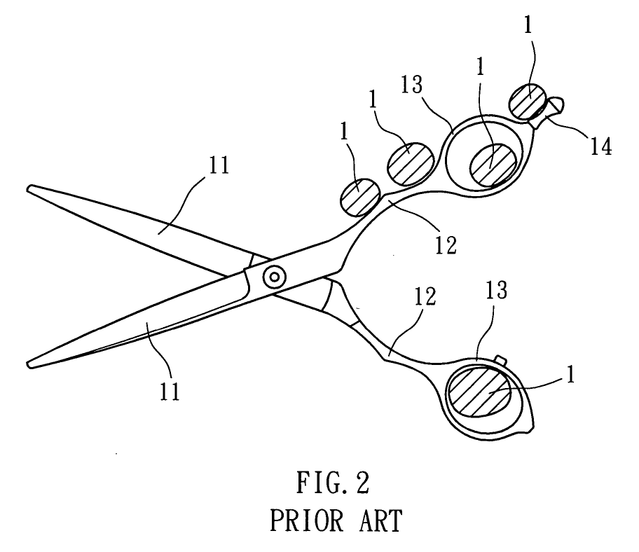

### DETAILED DESCRIPTION OF THE PREFERRED EMBODIMENT

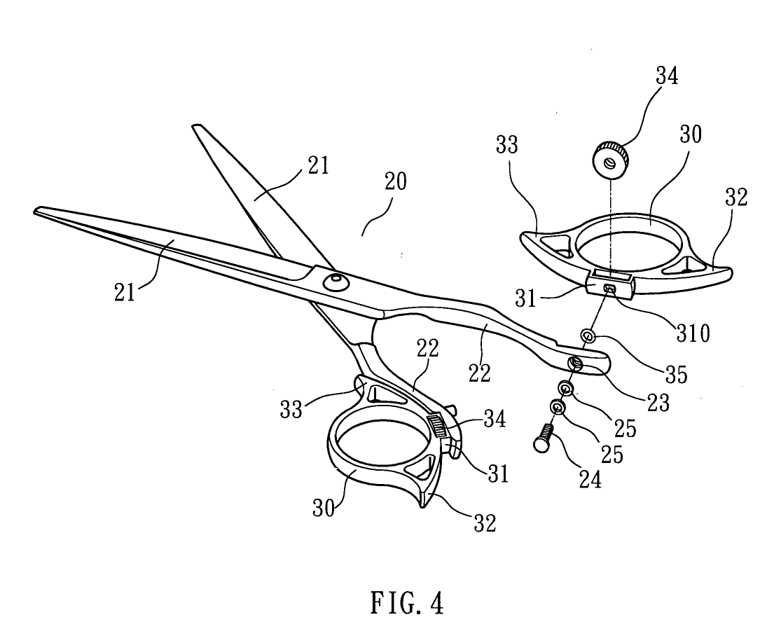

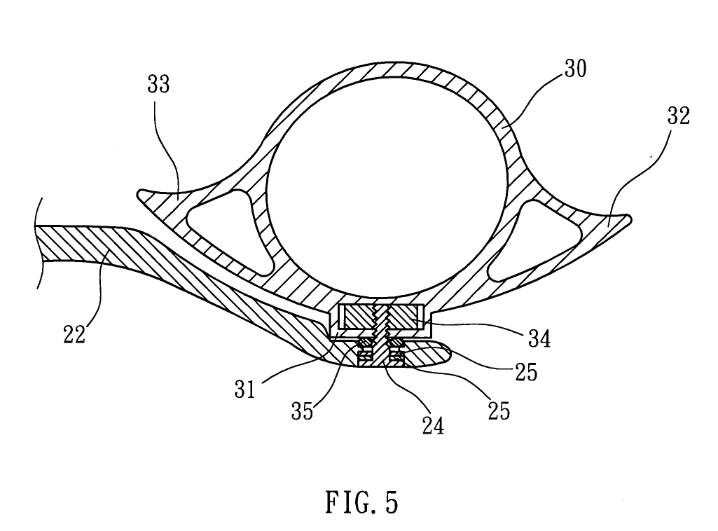

Referring to FIGS. 4 and 5, a handle structure of scissors 20 of the present invention basically has two blades joined pivotally to each other with an elongated stem 22 extending rearward respectively. The elongated stem 22 at the rear end thereof has an axial hole 23. A ring handle part 30 is attached to the rear end of the elongated stem 22. The ring handle part 30 has a projection seat 31 with a square engaging hole 310. An extension end 32, 33 is formed at two ends of the projection seat 31 respectively. The axial hole 23 can be passed through with an engaging bolt 24 for engaging the ring handle part 30 to the elongated stem 22. An O shaped soft ring 35 is disposed between the elongated stem 22 and the projection seat 31. The engaging bolt 24 is provided with a square end so as to be inserted to and pass through the square engaging hole 310 for being fastened with a nut 34. Hence, the elongated stem 22 can be secured with the ring handle part 30 and the engaging bolt 24 is kept unmoved while the nut 34 is rotated. Thus, the ring handle part 24 can be turned to and retain at an angular position with respect to the elongated stem 22 due to elasticity and friction of the O ring 35. Further, washers 25 can be arranged between the head of the engaging bolt 24 and the axial hole 24 to enhance the elasticity and the friction such that preferable effect for turning and locating the ring handle part 30 can be obtained substantially.

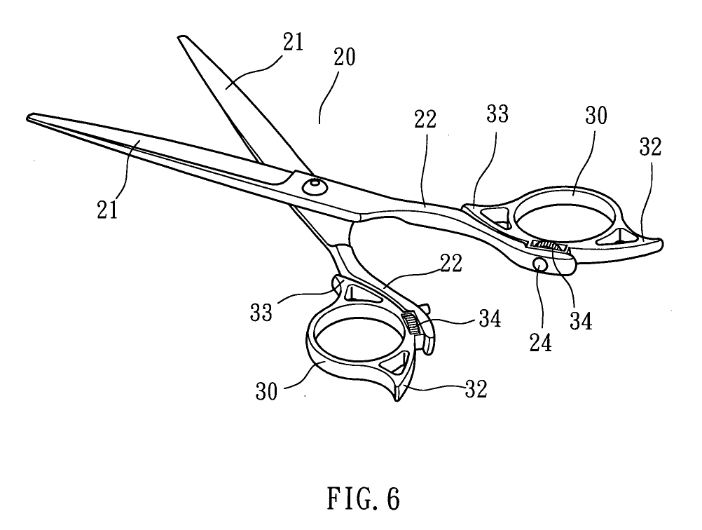

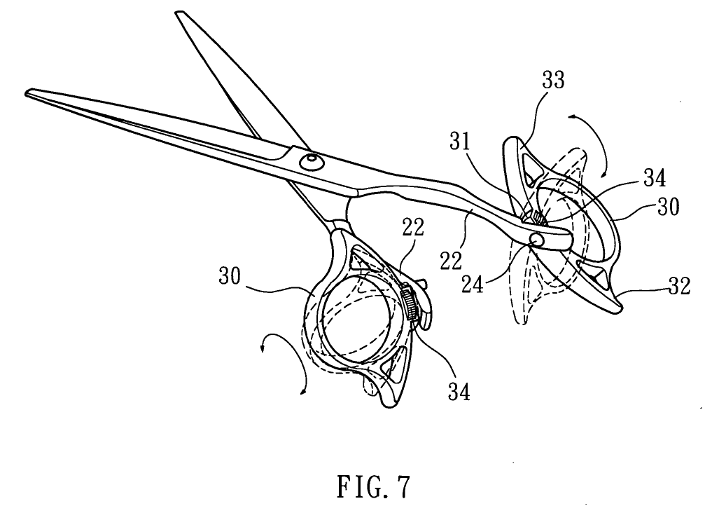

Referring to FIG. 6, the ring handle part 30 can be disposed at a normal position without angular displacement with respect to the elongated stem 22 as shown in FIG. 6 after being assembled to the elongated stem 22. Referring to FIG. 7, the ring handle part 30 can be adjusted to have any angular positions with respect to the elongated stem 22. As forgoing, the ring handle part 30 can be rotated to any angular positions and stay there due to the elasticity and friction generated from the washers 25 and the O shaped rubber ring 35 and it is preferable that the washer 25 and the O shaped ring 35 are made of anti-wear, elastic and better friction material such as Teflon, rubber or PE plastics. In this way, effects of elastic tight fit and friction resistance can be obtained between the elongated stem 22 and the projection seat 31 of the ring handle part 30. Hence, the ring handle part 30 can be located steadily after being turned unless a further turning force is exerted again.

It is noted that the preceding explanation is for an elongated stem 22 being attached with a ring handle part 30 only and, actually, there are two pairs of elongated stems and ring handle parts 30.

Advantages for the scissors of the present invention are listed hereinafter:

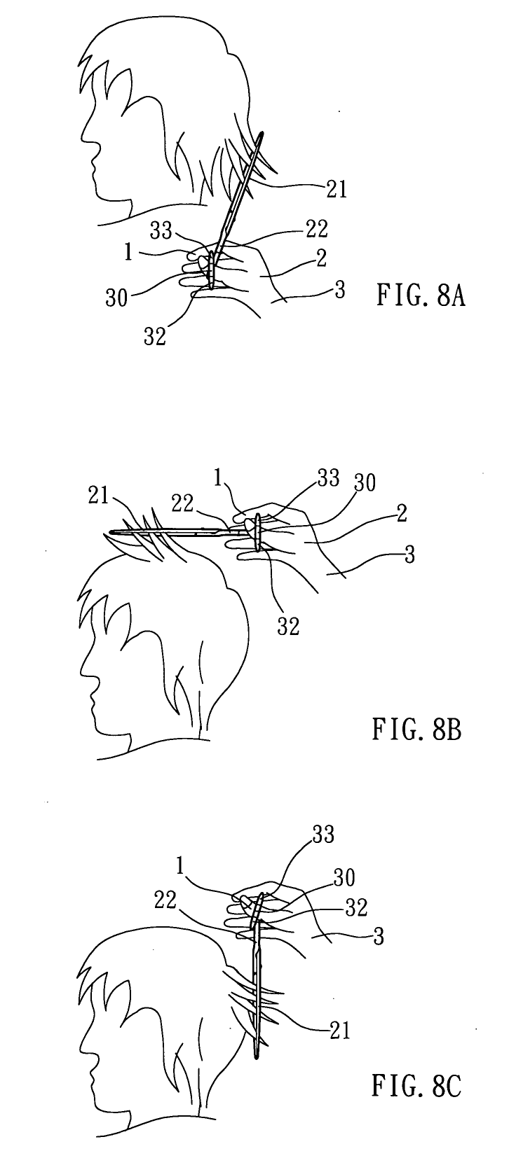

1. The blades 21 can be disposed upwards during the elongated stems and the ring handle parts 30 being disposed downwards with the ring handle parts having an angular position with respect to the elongated stems respectively as shown in FIG. 8A. The blades 21 and the elongated stems can be disposed horizontally during the ring handle parts 30 being disposed vertically as shown in FIG. 8B. The blades 21 can be disposed toward downward and the elongated stems 22 and the ring handle parts 30 being disposed upwards as shown in FIG. 8C.

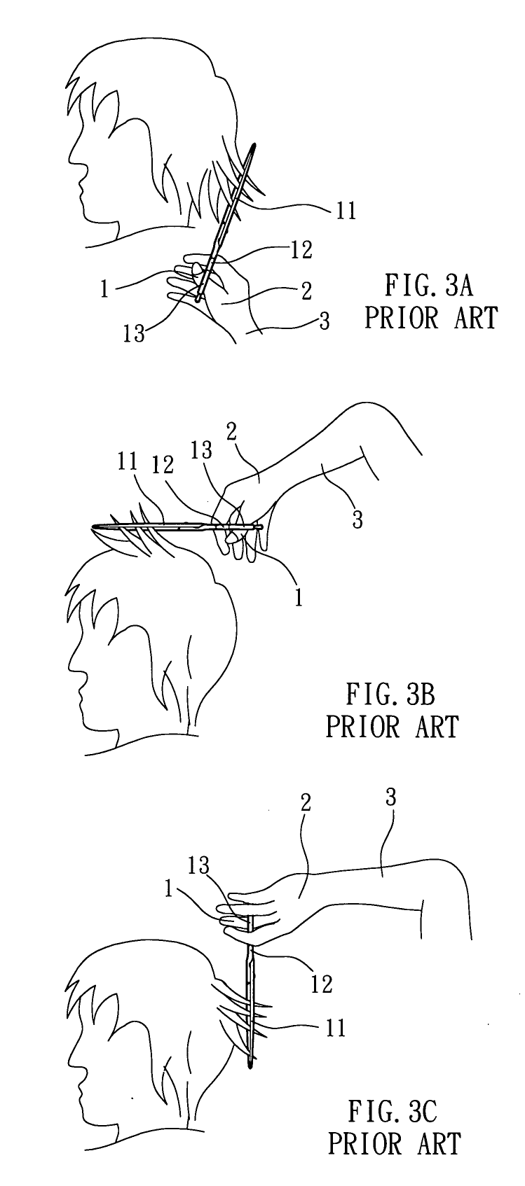

2. The user always keeps his fingers 1, palm 2 and elbow 3 at the same postures regardless what positions of the scissors shown in FIGS. 8A, 8B and 8C are instead of the postures of the fingers 1, palm 2 and elbow 3 being changed shown in FIGS. 3A, 3B and 3C. Hence, the present invention offers the user the most comfortable working postures for operating the scissors due to the fingers 1, palm 2 and elbow 3 being disposed and moved in accordance with the human engineering so that it is operated conveniently and it is not easy to result in fatigued and injured hand.

3. The user can move less due to the ring handle parts being able to change positions thereof based on cutting positions so as to enhance cutting efficiency.

4. Extension ends 32, 33 of the ring handle part 30 are able to be kept contact with fingers in spite of what angular positions of the ring handle part 30 are rotated to assist moving the elongated stems 22 during operating the scissors.

While the invention has been described with referencing to a preferred embodiment thereof, it is to be understood that modifications or variations may be easily made without departing from the spirit of this invention, which is defined by the appended claims.

What is claimed is:

1. A handle structure of scissors, comprising:
a pair of elongated stems, each of the elongated stems extending frontward a blade and having an axial hole being located at an rear end thereof;
a pair of ring handle parts, each of the ring handle parts being provided with a projection seat with a square engaging hole;
an elastic O shaped ring with friction surface, being disposed between the respective elongated stem and the respective projection seat;
an engaging bolt, providing a square rear end for being inserted into the square engaging hole via the axial hole; and
a nut, engaging the engaging bolt from the rear end of the engaging bolt such that the respective ring handle part is movably fastened to the respective elongated stem in a way of the engaging bolt being unmoved during fastening;
whereby, the respective ring handle part can be rotated to any angular positions with respect to the elongated stem and retain the angular positions by way of the elasticity and friction of the O shaped ring.

2. The handle structure as defined in claim 1, wherein at least a washer is disposed between the elongated stem and a head of the engaging bolt for increasing the elasticity and friction so as to enhance effect of keeping the angular positions in place.

3. The handle structure as defined in claim 1, wherein both ends of the projection seat extend an extension part respectively for being touched with fingers.
